(19) United States
(12) Patent Application Publication
(10) Pub. No.: US 2007/0088830 A1
(43) Pub. Date: Apr. 19, 2007

(54) SELECTIVE COMMUNICATION OF A MOBILE APPLICATION BASED ON AIR INTERFACE DORMANCY

(75) Inventor: Michael S. Borella, Naperville, IL (US)

Correspondence Address: PATENTS AND LICENSING LLC;DANIEL W. JUFFERNBRUCH, 28 BARRINGTON BOURNE, BARRINGTON, IL, 60010-9605, US

(73) Assignee: UTSTARCOM, INC., Alameda (US)

(21) Appl. No.: 11/163,455

(22) Filed: Oct. 19, 2005

(51) Int. Cl. G06F 15/16

(52) U.S. Cl. 709/227

(57) ABSTRACT

Applications on a mobile radio device selectively communicate over a wireless network based on a dormancy of the air interface. Middleware is provided between the applications and drivers of the mobile radio device for facilitating communication sessions based on the dormancy status of the air interface. The middleware effects selective communication sessions, in one embodiment, by informing applications of the state of the air interface and, in another embodiment, to allow and disallow one or more communication sessions.

### BACKGROUND OF THE INVENTIONS

1. Technical Field

The present inventions relate to communication over an air interface and, more particularly, relate to selective communication of a mobile application over an air interface.

2. Description of the Related Art

CDMA wireless data networks have a concept of dormancy. When a mobile device is not actively using an RF traffic channel, the traffic channel is taken away by the base station or base station controller and preferably assigned to a mobile that has data to send or receive. When a mobile is registered on the network but not allocated a traffic channel, the mobile is said to be dormant.

Dormancy is an important concept in CDMA, because traffic channels are the most valuable resource in the network. The temporal multiplexing of traffic channels suits the needs of bursty data applications, as it gives the bandwidth to mobiles that need it and does not allocate bandwidth to idle mobiles. CDMA operators try to conserve traffic channels as much as possible.

A problem arises when a CDMA data transceiver is put into the form factor of a PCMCIA card. When plugged into a laptop, the card becomes just like any other network interface. Certain applications periodically or regularly request communications with associated servers on the network. These applications do not necessarily know whether they are using CDMA RF rather than 802.11 or Ethernet.

### SUMMARY OF THE INVENTIONS

An object of the present inventions is to allow applications to communicate more effectively over wireless channels.

A further object of the present inventions is to delay periodic and/or regular communications requests with associated servers on a wireless network.

Another further object of the present inventions is to keep a radio communications channel open for periodic and/or regular communications requests with associated servers on the network when of critical importance.

A further additional object of the present inventions is to delay periodic and/or regular communications requests with associated servers on a wireless network when not of critical importance.

Another object of the present inventions is for applications to have the opportunity to “piggyback” on a wireless channel that has already become active for some other application to use.

An additional object of the present inventions is to enable concurrent sessions to efficiently utilize the air interface when available.

A further additional object of the present inventions is to enable concurrent sessions to efficiently utilize the air interface when available by enabling some and not other sessions, so that the air interface to the user appears available always.

Applications on a mobile radio device selectively communicate over a wireless network based on a dormancy of the air interface. Middleware is provided between the applications and drivers of the mobile radio device for facilitating communication sessions based on the dormancy status of the air interface. The middleware effects selective communication sessions, in one embodiment, by informing applications of the state of the air interface and, in another embodiment, to allow and disallow one or more communication sessions.

These and other objects and features of the inventions will be more readily understood from the following detailed description when read in conjunction with the accompanying drawings wherein:

### BRIEF DESCRIPTION OF THE DRAWINGS

FIG. 1 illustrates a schematic block diagram of a portable computer interfaced to a mobile radio;

FIG. 2 illustrates a schematic block diagram of a mobile device;

FIG. 3 illustrates an exemplary software stack of the present inventions according to a first embodiment;

FIG. 4 illustrates a flow diagram in a mobile device of the present inventions according to a first embodiment;

FIG. 5 illustrates an exemplary software stack of the present inventions according to a second embodiment; and

FIG. 6 illustrates a flow diagram in a mobile device of the present inventions according to a second embodiment.

### DETAILED DESCRIPTION OF THE PREFERRED EMBODIMENTS

A wireless radio such a CDMA cellular module presents status information to applications so that applications can make intelligent decisions on whether or not to communicate. In doing so, wireless RF resources are conserved because each mobile device's communications are “batched” to take advantage of the traffic channel when it is available, and to conserve bandwidth when it is not.

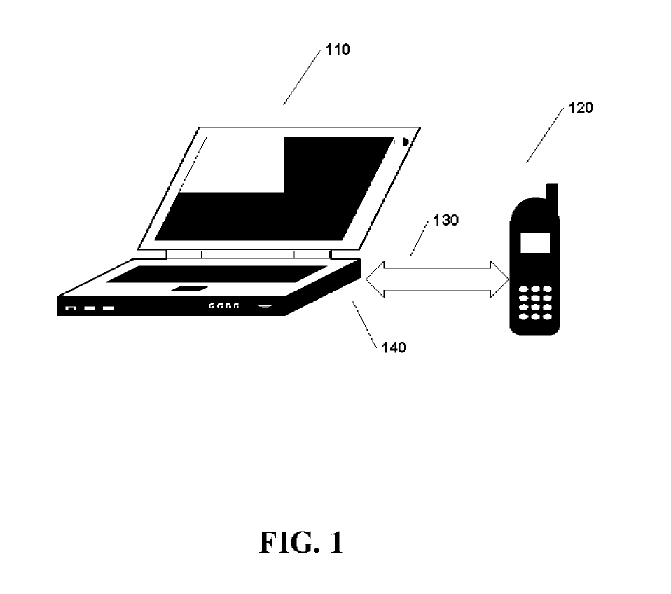

FIG. 1 illustrates a schematic block diagram of a portable computer 110 interfaced to a mobile radio 120 such as the radio unit of a mobile telephone. The mobile radio 120 can interface to the portable computer 110 via a cable 130. In one embodiment the mobile radio 120 is a radio modem on a PC card, such as an EVDO card, that fits into a PCMCIA slot 140 of the portable computer 110. The portable computer 100 can typically has one of a number of operating systems such as Windows, Mac OS or Linux. Various applications such as e-mail, instant messaging, online games, RSS clients, web browsing, VOIP telephony, and peer-to-peer applications reside on the portable computer 110. These applications exist in a software stack above the operating system of the portable computer 110. Typically these applications use a constantly available wired connection to access a wide area network such as the so-called Internet. In the embodiments of the present inventions, these applications utilize the wireless connection of a mobile radio using its air interface to access a wide area network such as the Internet.

Typically these applications demand access to the wide area network when needed. Because the wired connection, such as 10/100/1000 ethernet, or a wireless LAN such as 802.11, is nearly constantly available, conventional Internet applications expect the network to be there when communication is needed. On a mobile wireless network, however, constant access of the wireless network is impractical for many reasons. One reason is the scarcity of the mobile wireless bandwidth. Another reason is the overhead of setting up a session over the air interface. A further reason is the character of a mobile link which is subject to blank-outs due to fades or handoffs between cells. The present inventions provide middleware between these applications and the drivers of the mobile device for selective communication of these applications based on a dormancy status of the air interface.

The present inventions tend to be applicable to a class of applications that may have some the following characteristics:

1. They periodically or on user request communicate with a remote server;

2. They can be configured to periodically communicate with the remote server;

3. They can be instructed to immediately communicate with the remote server by the user;

4. Some portion of the communications result in minimal or no state change on the client application (in other words, the communication did not contain new and/or useful information); and

5. They do not need to present information to the user in strict “real time” (in other words, if the application does not communicate with the server every so often, then the user's experience is not seriously degraded).

These applications can be modified to take advantage of knowledge of the dormancy status of the wireless mobile network.

Example applications that fall into this category are described below. Note that this is not an exhaustive list of applications.
Instant messaging. Many, if not all instant messaging applications provide the user with a sense of the “presence” status of other users, such as whether or not these users are logged on, busy, idle, etc. Instant messaging clients periodically poll instant messaging servers to update this status. In many cases if the instant messaging client is not updated every n minutes, the user experience is not impacted.
Online games. While some games are strictly real time and need to continuously update the user with status, other games may allow for longer times between updates. For example, an on-line chess game would exhibit a long “think time,” probably minutes, between moves.
RSS clients. RSS clients periodically request updates from RSS feeds. Typically these updates are requested every n minutes. However, the RSS news content is typically known to be not delivered in real time. Thus if the RSS client occasionally skips an update, the user might not even notice.
E-mail clients. Many e-mail clients, such as POP3 clients, must periodically poll their server to determine if new e-mail has arrived for the user. If so, the e-mail is typically downloaded or the user is given an indication of the e-mail's arrival. However, like the RSS feed case, if the e-mail client occasionally skips an update, the user might not even notice.

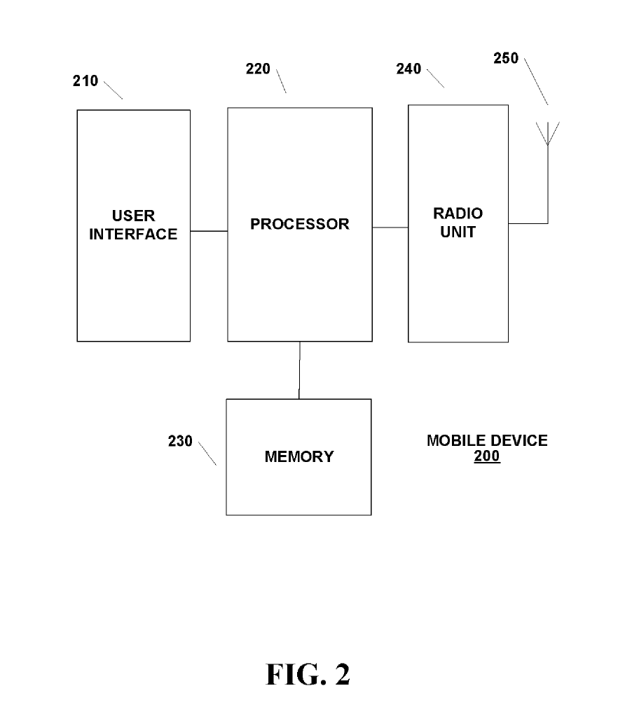

FIG. 2 illustrates a schematic block diagram of a mobile device 200 such as a mobile telephone or smart phone. A processor 220 couples a radio unit 240 to a user interface 210 such as a keyboard and display and perhaps an earpiece and microphone. The radio unit 240 of has RF amplifiers for coupling to a wireless network through an antenna 250. The processor 220 cooperates together with memory 230 to perform its functions and provide the applications. These applications are typically stored in memory 230 and implemented by processor 220. The processor 220 implements an operating system for the mobile device 200. For portable electronic mobile devices example operating systems are Qualcomm REX, Symbian, Palm OS, Windows Mobile, Windows CE, Windows Desktop and Linux. The processor 220 implements middleware between the applications and drivers of the radio unit 240 for selective communication of these applications based on the dormancy status of the air interface.

The middleware is a piece of logic that performs a function between and the applications and drivers. The location of the middleware in the software stack depends on the choice of operating system.

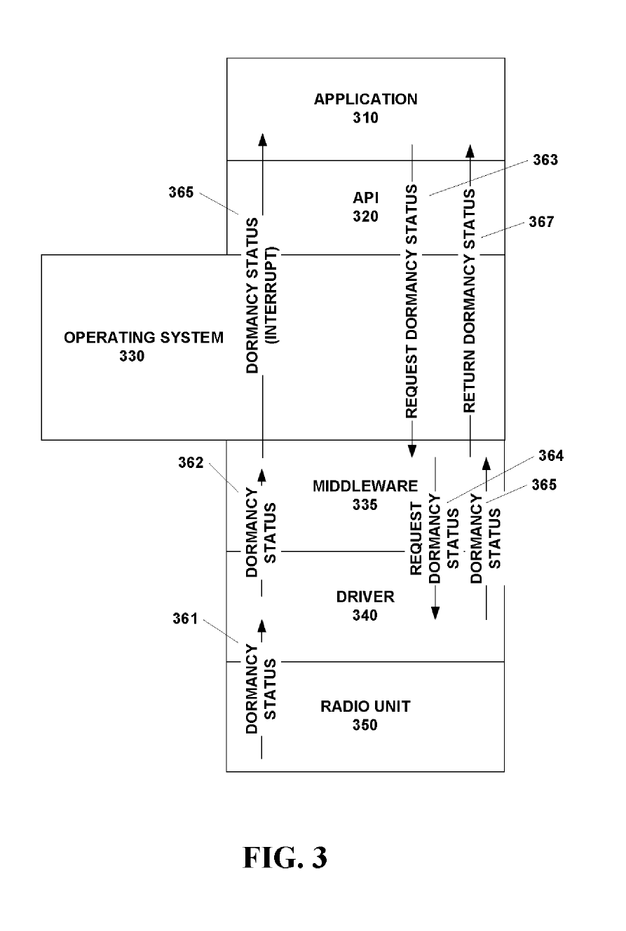

FIG. 3 illustrates an exemplary software stack of the present inventions according to a first embodiment. An application 310 resides on an operating system 330. An application programming interface (API) 320 couples the application 310 to the operating system 330. The application programming interface 320 can be a set of function calls which include options for the communications functionality. One understood example of an API could be the BSD socket interface. The operating system 330 resides on the hardware 350 of a portable computer such as a laptop or of a mobile device such as a mobile telephone or smart phone. A driver 340 couples the operating system 330 to the hardware 350.

Middleware 335 is provided between and the application 310 and the driver 340. The middleware 335 is a piece of logic that performs a function between the applications and drivers. The middleware 335 facilitates selective communication of the mobile applications based on air interface dormancy.

The location of the middleware in the software stack depends on the choice of operating system. The operating system used in the example illustrated in FIG. 3 cooperates best with middleware located between the operating system 330 and the driver 340. In some operating system environments the middleware 335 and the drivers 340 can be one in the same.

In this first embodiment, according to a first approach, the application 310 requests of the middleware 335 the air interface dormancy status indication at 363. The middleware 335 requests of the driver 340 the air interface dormancy status at 364. The driver 340 then reports the dormancy status of the radio unit to the middleware 335 at 365. The middleware 335 reports the dormancy status to the application 310 at 367. The application 310 then knows when to best communicate over the air interface of the radio unit 350 based on its dormancy status.

In this first embodiment, according to a second approach, the radio unit 350 of the hardware continually reports its dormancy status at 361 to the driver 340. The driver 340 continually reports the dormancy status of the radio unit to the middleware 335 at 362. The middleware continually reports the dormancy status to the application 310. Reporting may occur via an API 320. Reporting also may occur using interrupts or not. By using the middleware to facilitate reporting of the dormancy status to the application 310, the application 310 already knows when to best communicate over the air interface of the radio unit 350 based on its dormancy status.

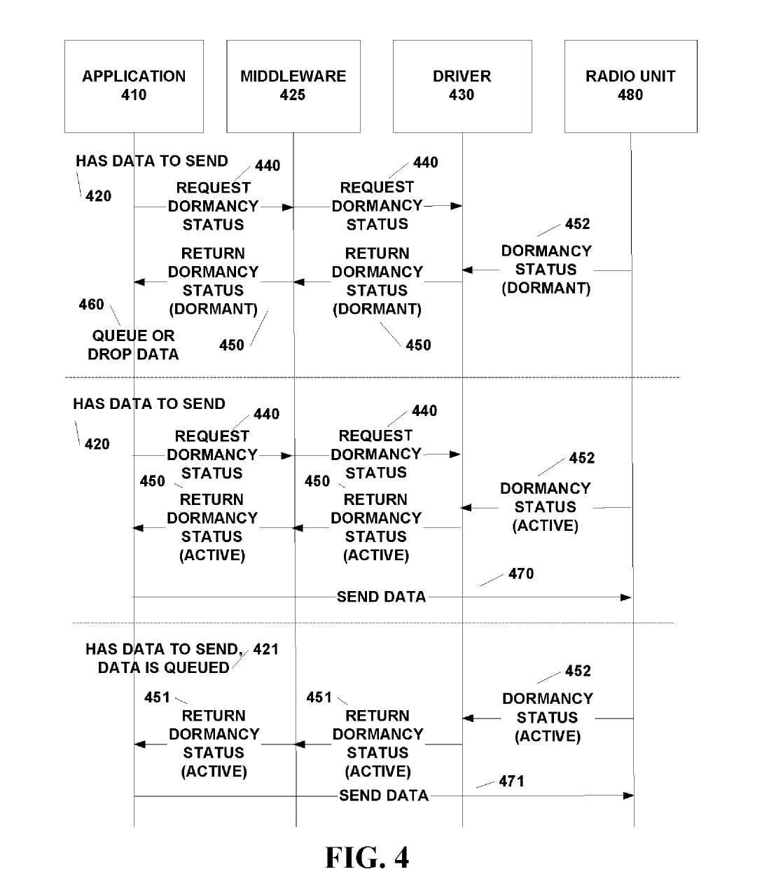

FIG. 4 illustrates a flow diagram in a mobile device of the present inventions according to a first embodiment. According to a first approach of the first embodiment, an application 410 has data to send at step 420. The application 410 then requests the dormancy status of a driver 430 at step 440 via the middleware 425. The dormancy status request 440 is facilitated by the middleware 425. The driver 430 and middleware 425 then return the dormancy status of the air interface at step 450. The dormancy status is known to the driver 430 when the radio unit 480 reports it at step 452. When the dormancy status is inactive, the application 410 queues or drops the data at step 460. When to the dormancy status is active, the application 410 sends the data to radio hardware 480 at step 470. Middleware 425 facilitates status communication between the radio unit 480 and its driver 430 in a way that is useful to the application 410.

According to a second approach of the first embodiment, the application 410 has data to send at step 421. The application 410 has been continually monitoring the dormancy status of the air interface via the middleware 425 and driver 430 at step 451. When to the dormancy status is active, the application 410 sends the data to radio hardware 480 at step 471. When the dormancy status is inactive, the application 410 can queue or drop the data.

The basic strategy that we take is as follows. Software or firmware (for example, a driver) associated with the CDMA wireless interface presents a mechanism with which the application can discover the dormancy status of the CDMA air interface. This mechanism preferably has two parts:
Polling mode: A binary value that can be polled by the application that indicates whether or not the air interface is dormant.
Indication mode: An indicator that can be used in conjunction with a callback function in the application. The indicator preferably notifies the application when the air interface dormancy status changes (active to dormant or dormant to active).

Client operation would be as follows. If the driver is in polling mode and the application has non-critical real-time data to send, the application would first poll the driver. If the CDMA air interface is active, the application would proceed to send the data. If the CDMA air interface is dormant, the application would defer sending the data for a period of time.

Similarly, if the driver is in indication mode and the application has non-critical real-time data to send, the application will examine the most recent indication from the driver. If this indication is that the air interface is active, the application would proceed to send the data. If the indication is that the air interface is dormant, the application would defer sending the data for a period of time.

Also if the driver is in indication mode, applications may defer or queue communications when the air interface is dormant. When the air interface becomes active, the driver will notify all registered applications. These applications then have the opportunity to “piggyback” their on an air interface that has already become active for some other application to use. For example, if a user starts a web browsing session, an RSS client that has previously been deferred may decide to update its feeds at that point.

In the first embodiment, the application knew when best to communicate over the air interface based on the dormancy status, with help of the middleware. Nevertheless, not all applications are capable of knowing when best to communicate. For example, conventional applications, such as e-mail, instant messaging and web browsers are designed for conventional portable computers such as laptops. They communicate over a network regardless of its dormancy status of the network. This is because conventional applications have been designed for communication over a continuously available, wired network.

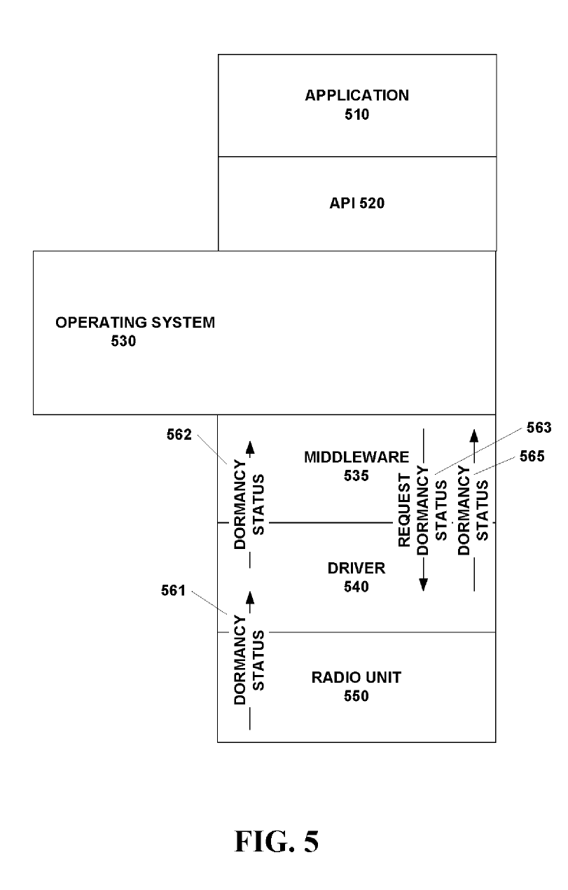

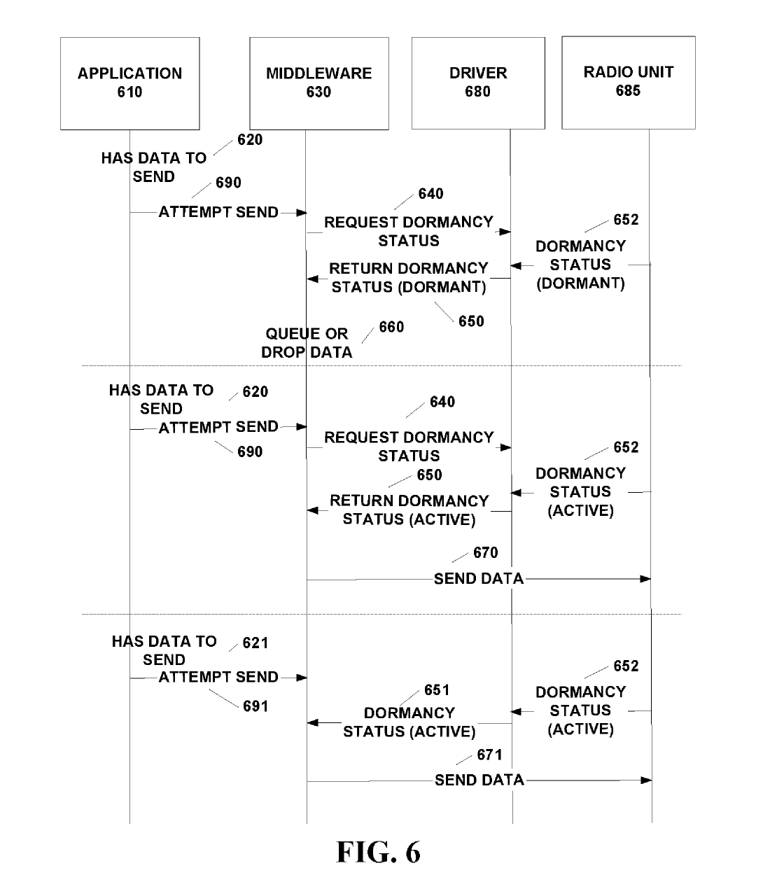

In a second embodiment (according to FIGS. 5 and 6), rather than the application knowing when to best communicate over the air interface based on its dormancy status, the middleware decides for the application whether to allow or permit communication over the air interface of a wireless network. This allows such conventional applications to continue to be used in a way that conserves wireless network resources.

FIG. 5 illustrates an exemplary software stack of the present inventions according to a second embodiment. An application 510 resides on an operating system 530. An application programming interface (API) 520 couples the application 510 to the operating system 530. The operating system 530 resides on the radio unit hardware 550 of a portable computer such as a laptop or of a mobile device such as a mobile telephone or smart phone. A driver 540 couples the operating system 530 to the hardware 550.

Middleware 535 is provided between and the application 310 and the driver 540. The middleware 535 is a piece of logic that performs a function between the applications and drivers. The middleware 535 allows for selective communication of the mobile applications based on air interface dormancy.

The location of the middleware in the software stack depends on the choice of operating system. The operating system used in the example illustrated in FIG. 5 cooperates best with middleware located between the operating system 330 and the driver 340. In some operating system environments the middleware 335 and the drivers 340 can be one in the same.

In the second embodiment, according to a first approach, the middleware 535 requests of the driver 540 the air interface dormancy status indication at 563. The driver 540 then reports the dormancy status to the middleware at 565. The middleware then permits communication by the application over the air interface of the radio.

In the second embodiment, according to a second approach, the radio unit 550 of the hardware continually reports its dormancy status at 561 to its driver 540. Its driver 540 continually reports its dormancy status at 562 to the middleware 535. Reporting also may occur using interrupts or not. When an application 510 attempts a communication over the air interface of the radio unit 550, the middleware then knows the status of the air interface and can allow or deny the communication.

A decision whether or not to communicate based on the dormancy status of the air interface can be made more intelligently based on priority factors and the kind of application according to further implementations of the first and second embodiments of the present inventions. In the first embodiment, the application learns its priority and monitors a predetermined amount to decide when to use the air interface. The middleware can facilitate the application learning this status. In the second embodiment, the middleware knows the priority of each application and monitors a predetermined amount to decide when to allow use of the air interface.

There would be some instances in which the mechanism could be overridden. If the application or middleware decides that the communication does not fall into the class of “non-critical real-time” data, the application may transmit the data without first checking the dormancy status of the air interface. Also, if the communication is requested by a user, such as the user manually refreshing their POP3 client or an RSS feed, then the communication should occur regardless of the dormancy status of the CDMA interface.

In the second embodiment the middleware may know the priority of each application. One way the middleware can know the priority of each application by examining the communication packets within a communication request. Another way the middleware can know the priority of each application by recognizing the name and/or type of application requesting communication. The name or type is recognized by the middleware by comparing incoming packets in a communication attempt against a list of known names and types of the application requesting communication. This list might be occasionally updated to include new kinds of applications.

The data communication can be disabled by deferring sending data for a predetermined amount. After the predetermined amount, sending the data and thereby forcing the air interface active. The predetermined amount is shorter for higher priority applications. The predetermined amount is a predetermined period of time in one implementation. The predetermined amount is a predetermined number of retries in another implementation.

The application itself may on occasion decide to override the dormancy status as well. One of the reasons that an application may do this is that it has been deferred a certain number of times or for a certain period of time. For example, a weather application that presents the local temperature to the user may be programmed to check the current temperature at a remote server every 15 minutes. However if the CDMA air interface has been dormant last n times (e.g., 4 times) it has tried to communicate with the server, or due to dormancy it has been unable to communicate with the server for n minutes (e.g., 60 minutes), it may decide to initiate the communication, thus activating the air interface. In these scenarios, the application has determined that updating its status is more important than conserving bandwidth. Note that when an application is first launch or when a CDMA network interface first becomes available after no network interface has been available for a period of time, the application should not defer its communications with the server.

The updates discussed here are “non-critical real-time” communications. In other words, if the updates are missed or deferred, the user experience is not deleteriously impacted. The goal of this work is to allow the application to decide whether or not to send updates of this type when the wireless air interface is dormant. Critical “real-time” updates, such as web page requests, FTP transfers or voice over IP calls would be not be subject to deferral.

FIG. 6 illustrates a flow diagram in a mobile device of the present inventions according to a second embodiment. According to a first approach of the second embodiment, an application 610 has data to send at step 620. The application 610 then attempts to send the data at 690. The middleware 630 at step 640 then requests the dormancy status of the air interface at the radio unit 685 from the driver 680. The driver 680 knows the dormancy status when the radio unit 685 reports it at step 652. The driver 680 then returns the dormancy status of the air interface at step 650. When the dormancy status is inactive, the middleware 630 queues or drops the data at step 660. When to the dormancy status is active, the middleware 630 sends the data to radio unit 685 at step 670.

According to a second approach of the second embodiment, the application 610 has data to send at step 621, and the application 610 attempts to send the data at 690. The middleware 630 has been continually monitoring the dormancy status of the air interface at step 651. And the radio unit 685 reported the status of the air interface to the driver 680 at 652. When to the dormancy status is active, the middleware 630 sends the data to the radio unit 680 at step 671. When the dormancy status is inactive, the middleware 630 can queue or drop the data.

Wireless networks currently suffer from “chatty” mobile applications. A wireless client interface can present some indication of network status to applications. The applications may then use this indication to decide whether or not to transmit data over the wireless network.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure. For example, although wireless examples are disclosed, the inventions are applicable to other bandwidth sensitive or intermittently available communication mediums.

What is claimed is:

1. A mobile device capable of communication over an air interface of a wireless network, comprising:
a radio unit for communication over the air interface of the wireless network;
a processor and memory operatively coupled to the radio unit to provide one or more applications capable of selective communication over the air interface of the wireless network and to provide middleware between the applications and drivers of the radio unit for effecting selective communication sessions based on a dormancy status of the air interface.

2. A mobile device according to claim 1, wherein the mobile device comprises a mobile telephone.

3. A mobile device according to claim 1, wherein the mobile device comprises a portable computer.

4. A mobile device according to claim 1, wherein the middleware disables data communication by one or more applications over the air interface when the dormancy status indication indicates that the air interface is dormant.

5. A mobile device according to claim 1, wherein the middleware allows data to be sent over the air interface by high priority applications regardless of the air interface dormancy status.

6. A method for selective communication by an application on a mobile device based on the dormancy status of an air interface of a wireless network, said method comprising the steps of:
(a) operating one or more applications that communicate over the wireless network; and
(b) providing middleware between the applications and drivers of the mobile device for effecting selective communication sessions based on a dormancy status of the air interface.

7. A method according to claim 6, wherein the step (b) of providing the middleware for effecting selective communication sessions comprises the step of (b1) using the current status of the air interface to inform applications of the state of the air interface of the mobile device.

8. A method according to claim 7, wherein said step (b1) of using the current status of the air interface to inform applications of the state of the air interface comprises the substep of (b1i) indicating whether or not the state of the air interface of the mobile device is dormant.

9. A method according to claim 7, further comprising the step of (c) operating the one or more applications in accordance with the dormancy status so indicated.

10. A method according to claim 9, wherein said step (c) of operating the application in accordance with the dormancy status so indicated comprises the substep of (c1) disabling data communication by the application over the air interface when the dormancy status indication indicates that the air interface is dormant.

11. A method according to claim 6, wherein the step (b) of providing the middleware for effecting selective communication sessions comprises the step of (b1) deferring sending data for a predetermined amount.

12. A method according to claim 11, wherein the predetermined amount is shorter for higher priority applications.

13. A method according to claim 11, wherein the predetermined amount is a predetermined period of time.

14. A method according to claim 11, wherein the predetermined amount is a predetermined number of retries.

15. A method according to claim 11, wherein the step (b) of providing the middleware for effecting selective communication sessions further comprises the step of (b2) after the predetermined amount, sending the data and thereby forcing the air interface active.

16. A method according to claim 6, wherein the step (b) of providing the middleware for effecting selective communication sessions further comprises the step of (b1) enabling data communication by the application over the air interface when the dormancy status indication indicates that the air interface is active.

17. A method according to claim 7, wherein the step (b) of providing the middleware for effecting selective communication sessions comprises the step of (b1) notifying the one or more applications when a state of the air interface of the mobile device changes.

18. A method according to claim 6, wherein the step (b) of providing the middleware for effecting selective communication sessions comprises the step of (b1) for high priority applications, sending data regardless of the air interface dormancy status indication and thereby forcing active the air interface.

19. A method according to claim 6, wherein said step (b) of providing the middleware for effecting selective communication sessions of comprises the step of (b1) using the current status of the air interface to allow and disallow one or more communication sessions by applications over the air interface of the wireless network based on a state of the air interface of the mobile device.

20. A method according to claim 19, wherein said step (b) of providing the middleware for effecting selective communication sessions of comprises the step of (b1) using the middleware to selectively permit one or more applications to communicate over the air interface of the wireless network when a state of the air interface of the mobile device changes.

21. A method according to claim 19, wherein said step (b) of providing the middleware for effecting selective communication sessions of comprises the step of (b1) using the middleware to selectively permit one or more applications to communicate over the air interface of the wireless network when the state of the air interface is not dormant.

22. A method for selective communication by an application on a mobile device based on the dormancy status of an air interface of a wireless network, said method comprising the steps of:
(a) providing a dormancy status indication to the application indicative of the dormancy status of the air interface; and
(b) operating the application in accordance with the dormancy status indication.
